(19) United States
(12) Patent Application Publication
(10) Pub. No.: US 2015/0019224 A1
(43) Pub. Date: Jan. 15, 2015

(54) VOICE SYNTHESIS DEVICE

(71) Applicants: Masanobu Osawa, Tokyo (JP); Tomohiro Iwasaki, Tokyo (JP)

(72) Inventors: Masanobu Osawa, Tokyo (JP); Tomohiro Iwasaki, Tokyo (JP)

(73) Assignee: MITSUBISHI ELECTRIC CORPORATION, Tokyo (JP)

(21) Appl. No.: 14/382,282

(22) PCT Filed: May 2, 2012
(86) PCT No.: PCT/JP2012/002972

§ 371 Date: Aug. 29, 2014

(51) Int. Cl. G10L 13/02; G10L 15/00

(52) U.S. Cl. CPC G10L 13/02; G10L 15/00
USPC 704/246

(57) ABSTRACT

A voice synthesis device according to the present invention regularly recognizes the contents of an utterance made by a passenger or the like, and specifies a word before abbreviation corresponding to an abbreviation included in a facility name or the like which is included in the utterance contents by using the facility name or the like. Therefore, the voice synthesis device can read the abbreviation out loud while preventing the passenger from being forced to perform a burdensome operation of, for example, registering the word before abbreviation corresponding to the abbreviation and using a reading method familiar to and appropriate for the passenger.

### FIELD OF THE INVENTION

The present invention relates to a voice synthesis device that generates a synthesized voice from an inputted character string and reads the synthesized voice out loud.

### BACKGROUND OF THE INVENTION

In recent years, a function of reading out loud a document, such as an SMS (Short Message Service) message, has become widely available in car navigation systems and so on.

However, it is hard to say that it is possible to appropriately read any type of document out loud. As an example, there is provided reading out of an abbreviation having a plurality of readings, such as “Dr” or “St” included in a facility name, an address name, a road name or the like (referred to as a “facility name or the like” from here on) in a document.

For example, because “St” has two possible readings: “Street” and “Saint”, a problem is that in the case of a road name of “Berkeley St”, whether “St” is “Street” or Saint” cannot be determined and the road name cannot be read out loud appropriately.

To solve this problem, there is provided, for example, a method of specifying how to read an abbreviation out loud by determining whether the position of the abbreviation is at the beginning or the ending of words (a first method). For example, in the case in which “St” which is an abbreviation is at the beginning of words, like in the case of “St Andrews Church”, it is determined that the abbreviation means “Saint”, whereas in the case in which “St” which is an abbreviation is at the ending of words, like in the case of “Berkeley St”, it is determined that the abbreviation means “Street.”

Further, as another method, there is a method of preparing a table defining a facility name or the like including an abbreviation and a facility name or the like which corresponds to the above-mentioned facility name or the like and for which how to read the abbreviation out loud is specified, and, when the facility name or the like including the abbreviation is detected, referring to the table and replacing this facility name or the like by the corresponding facility name or the like and reading this facility name or the like out loud (second method), as described in, for example, patent reference 1.

### RELATED ART DOCUMENT

### Patent Reference

Patent reference 1: Japanese Unexamined Patent Application Publication No. 2007-41443

### SUMMARY OF THE INVENTION

### Problems to be Solved by the Invention

A problem with conventional voice synthesis devices, such as a voice synthesis device based on the first method, is, however, that in the case in which an abbreviation is included in words, such as a facility name, like in the case of, for example, “MARTINE DR HOSPITAL”, a word before abbreviation corresponding to the abbreviation cannot be specified.

While this case can be handled by using, for example, the method described in the patent reference 1 (second method) to, for example, define “MARTINE DOCTOR HOSPITAL” corresponding to “MARTINE DR HOSPITAL” in advance, a problem with this method is that because it is necessary to make many definitions in advance, a large amount of memory is required.

In addition, in the case of a facility name or the like including an abbreviation having a plurality of readings at the same position, for example, in the case in which “Court 365” and “Connecticut 365” are assumed for an abbreviation of “CT 365”, it is impossible for a passenger using SMS or the like to determine which one of them is an appropriate reading by using either one of the above-mentioned methods. A problem is that although this case can be handled by enabling the passenger to register a reading appropriate for the passenger himself or herself, the passenger needs to perform a registering operation every time when a facility name or the like, such as the above-mentioned “CT 365”, appears, and this operation is burdensome to the passenger.

The present invention is made in order to solve the above-mentioned problems, and it is therefore an object of the present invention to provide a voice synthesis device that reads out loud an abbreviation included in a facility name or the like in such a way that the reading out is appropriate for a passenger using a function of reading out loud a document such as an SMS message.

### Means for Solving the Problem

In order to achieve the above-mentioned object, in accordance with the present invention, there is provided a voice synthesis device that generates a synthesized voice from inputted character strings, the voice synthesis device including: a voice acquiring unit that detects and acquires an inputted voice; a voice recognizer that regularly recognizes voice data acquired by the above-mentioned voice acquiring unit when the above-mentioned voice synthesis device is started; an abbreviation expansion word extractor that extracts abbreviation expansion words from character strings which are a recognition result outputted by the above-mentioned voice recognizer; an abbreviation expansion rule storage that stores rules for expansion of abbreviations; a voice synthesizer that generates a synthesized voice from the above-mentioned inputted character strings, and, when generating the above-mentioned synthesized voice, expands an abbreviation included in the above-mentioned inputted character strings by referring to the above-mentioned abbreviation expansion rule storage; an abbreviation unexpanded word storage that registers words for which the above-mentioned voice synthesizer has failed in expansion of an abbreviation; and an abbreviation expander that uses the abbreviation expansion words extracted by the above-mentioned abbreviation expansion word extractor to expand an abbreviation included in abbreviation unexpanded words registered in the above-mentioned abbreviation unexpanded word storage by referring to the above-mentioned abbreviation expansion rule storage.

### Advantages of the Invention

Because the voice synthesis device in accordance with the present invention regularly recognizes the contents of an utterance made by a passenger or the like, and specifies a word before abbreviation corresponding to an abbreviation included in a facility name or the like which is included in the utterance contents by using the facility name or the like, the voice synthesis device can read the abbreviation out loud while preventing the passenger from being forced to perform a burdensome operation of, for example, registering the word before abbreviation corresponding to the abbreviation and using a reading method familiar to and appropriate for the passenger.

### BRIEF DESCRIPTION OF THE FIGURES

FIG. 1 is a block diagram showing an example of a voice synthesis device in accordance with Embodiment 1;

FIG. 2 is a view showing an example of rules stored in an abbreviation expansion rule storage in accordance with Embodiment 1;

FIG. 3 is a flow chart showing a process of expanding an abbreviation when generating a synthesized voice from an inputted text in Embodiment 1;

FIG. 4 is a flow chart showing a process of expanding an abbreviation included in a facility name or the like which is registered in an abbreviation unexpanded word storage in Embodiment 1;

FIG. 5 is a block diagram showing an example of a voice synthesis device in accordance with Embodiment 2;

FIG. 6 is a view showing an example of rules stored in an abbreviation expansion rule storage in accordance with Embodiment 2;

FIG. 7 is a flow chart showing a process of, when a facility name or the like displayed on a touch panel is selected (indicated) by a passenger, registering the facility name or the like in an abbreviation unexpanded word storage in Embodiment 2;

FIG. 8 is a flow chart showing a process of, when generating a synthesized voice from an inputted text, expanding an abbreviation in Embodiment 2 (when a rule which is prohibited from being used and re-registered exists in an abbreviation expansion rule storage); and

FIG. 9 is a flow chart showing a process of expanding an abbreviation included in a facility name or the like registered in the abbreviation unexpanded word storage in Embodiment 2 (when a rule which is prohibited from being used and re-registered exists in the abbreviation expansion rule storage).

### EMBODIMENTS OF THE INVENTION

Hereafter, the preferred embodiments of the present invention will be explained in detail with reference to the drawings.

In accordance with the present invention, in a voice synthesis device that generates a synthesized voice from an inputted character string, when the voice synthesis device is started, the contents of an utterance by someone, such as a passenger in a vehicle, are recognized, and a word before abbreviation which corresponds to an abbreviation included in a facility name or the like which is included in the utterance contents is specified by using the facility name or the like. In the following embodiments, an explanation will be made by taking, as an example, a case in which the voice synthesis device in accordance with the present invention is applied to a car navigation system mounted in a moving object such as a vehicle.

### Embodiment 1

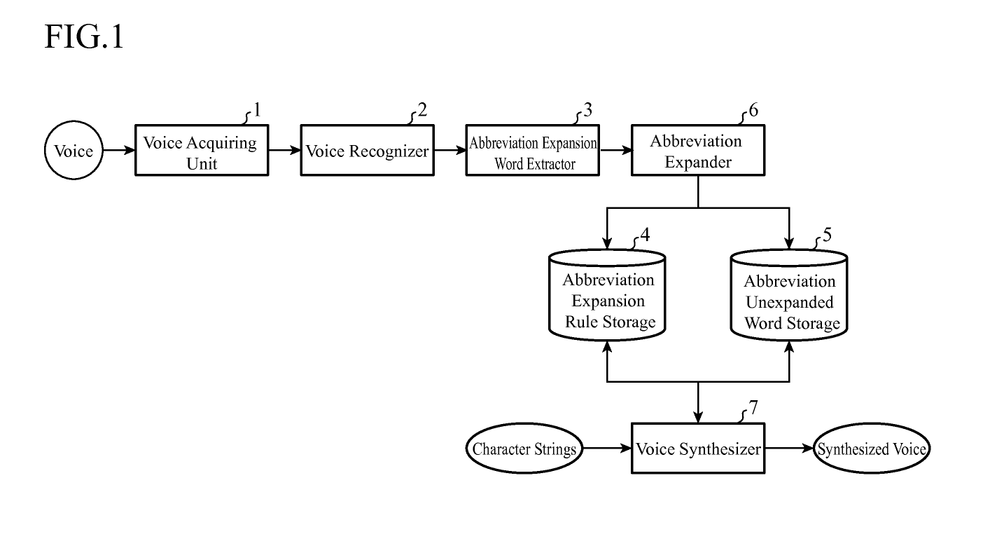

FIG. 1 is a block diagram showing an example of a voice synthesis device in accordance with Embodiment 1 of the present invention. This voice synthesis device includes a voice acquiring unit 1, a voice recognizer 2, an abbreviation expansion word extractor 3, an abbreviation expansion rule storage 4, an abbreviation unexpanded word storage 5, an abbreviation expander 6, and a voice synthesizer 7. Further, although not illustrated, this voice synthesis device also includes an input unit that acquires an input signal by using keys, a touch panel, or the like.

The voice acquiring unit 1 A/D converts a voice collected by a microphone or the like in a vehicle, such a passenger's utterance, a voice from a radio, or a voice from a television (referred to as a “passenger's utterance or the like” from here on) to acquire data in, for example, PCM (Pulse Code Modulation) form.

The voice recognizer 2 has a recognition dictionary (not shown), detects a voice interval corresponding to the contents of the passenger's utterance or the like from the voice data acquired by the voice acquiring unit 1, extracts a feature quantity of the voice data in the voice interval, performs a recognition process by using the recognition dictionary on the basis of the feature quantity, and outputs character strings which are a result of the voice recognition. The recognition process can be carried out by using a typical method such as an HMM (Hidden Markov Model) method. Further, the voice recognizer 2 can be disposed in a server on a network, as will be mentioned below.

By the way, in a voice recognition function mounted in a car navigation system and so on, typically, a passenger specifies (commands) a start of an utterance or the like for a system. To that end, a button or the like for commanding a lo start of voice recognition (referred to as a “voice recognition start commander” from here on) is displayed on a touch panel or is mounted in a steering wheel. After the voice recognition start commander is then pressed down by a passenger, an uttered voice or the like is recognized. More specifically, when the voice recognition start commander outputs a voice recognition start signal, and the voice recognizer receives this signal, after receiving this signal, the voice recognizer detects a voice interval corresponding to the contents of the passenger's utterance or the like from the voice data acquired by the voice acquiring unit and performs the above-mentioned recognition process.

However, even if the voice recognizer 2 in accordance with this Embodiment 1 does not receive such a voice recognition start command as mentioned above and issued by a passenger, the voice recognizer regularly recognizes the contents of a passenger's utterance or the like. More specifically, even when not receiving the voice recognition start signal, the voice recognizer 2 repeatedly carries out a process of detecting a voice interval corresponding to the contents of a passenger's utterance or the like from the voice data acquired by the voice acquiring unit 1, extracting a feature quantity of the voice data about this voice interval, performing a recognition process on the basis of the feature quantity by using the recognition dictionary, and outputting character strings which are a result of the voice recognition. Also in the following embodiments, the same process is carried out.

The abbreviation expansion word extractor 3 performs a morphological analysis on the character strings which are outputted by the voice recognizer 2 and which are the result of the voice recognition with reference to a map data storage (not shown) in which facility names or the likes are stored to extract abbreviation expansion words. In this specification, an “abbreviation” means a word, such as “Dr” or “DR” which is an abbreviation of “Doctor” or “Drive”, or “St” or “ST” which is an abbreviation of “Street” or “Saint.” Further, “expansion” means specification of a word before abbreviation corresponding to an abbreviation, and an “expanded word” means a word before abbreviation corresponding to an abbreviation. “Abbreviation expansion words” are words used at the time of expansion of an abbreviation, which will be mentioned below, and, for example, are a facility name or the like, such as a facility name, an address name, or a road name. In the following embodiments, these technical terms have the same meanings.

The abbreviation expansion word extractor 3 carries out the morphological analysis with reference to a database (not shown) in which phonetic information, position information, and so on about facility names or the likes are stored, and extracts a facility name or the like from the character strings which are the result of the voice recognition.

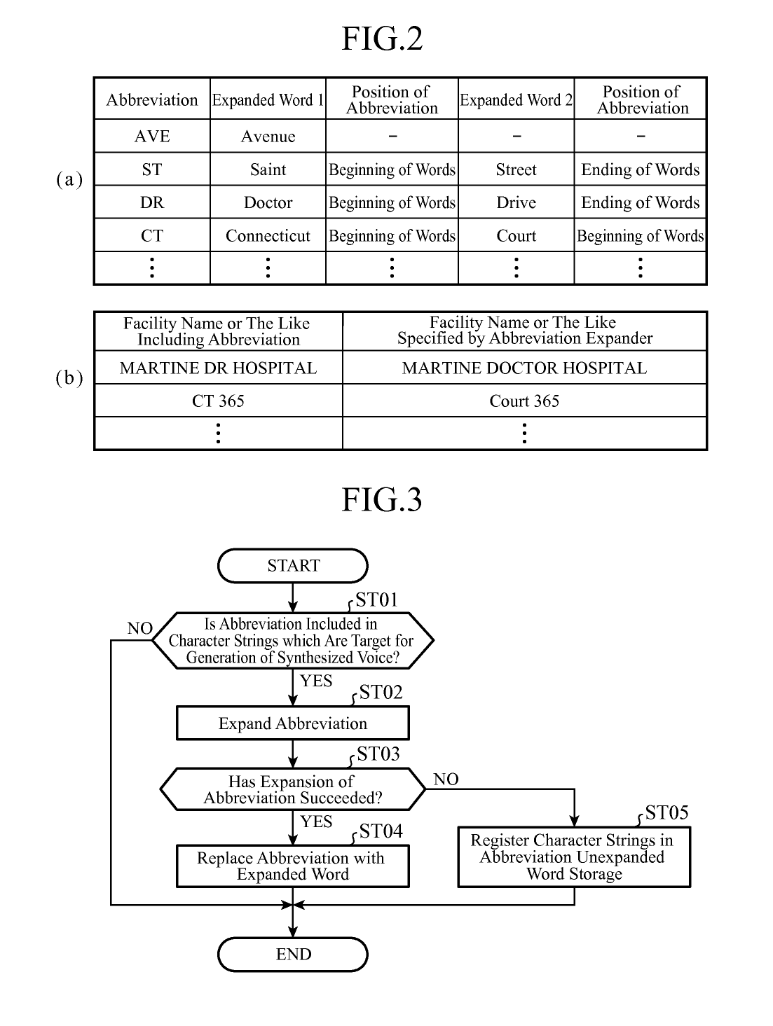

The abbreviation expansion rule storage 4 is the one in which rules for expanding an abbreviation are stored. FIG. 2 is a view showing an example of the rules stored in the abbreviation expansion rule storage 4 in accordance with Embodiment 1.

First, FIG. 2(a) shows the rules each of which is stored with an abbreviation, the position of the abbreviation in a facility name or the like, and an expanded word corresponding to the abbreviation being brought into correspondence with one another. For example, “Doctor” is brought into correspondence with an abbreviation “DR” and the position “beginning of words” of the abbreviation, and “Drive” is brought into correspondence with an abbreviation “DR” and the position “ending of words” of the abbreviation.

Information about “position” is limited to neither the information of “beginning of words” as shown in FIG. 2(a) nor the information of “ending of words” as shown in FIG. 2(a). A numerical value can be alternatively stored as the information in such a way that, for example, “0” is stored as the beginning of words and “1” is stored as the ending of words.

Further, FIG. 2(b) will be explained when explaining the abbreviation expander 6 which will be mentioned below.

The abbreviation unexpanded word storage 5 is the one in which facility names or the likes each including an abbreviation for which expansion of the abbreviation has failed when the voice synthesizer 7, which will be mentioned later, has carried out a voice synthesis process are stored.

The abbreviation expander 6 expands an abbreviation included in a facility name or the like stored in the abbreviation unexpanded word storage 5 with reference to the abbreviation expansion rule storage 4 by using the facility name or the like extracted by the abbreviation expansion word extractor 3. The abbreviation expander then registers the facility name or the like before abbreviation expansion and a facility name or the like after abbreviation expansion in the abbreviation expansion rule storage 4 while bringing these facility names or the likes into correspondence with the facility name or the like before abbreviation expansion.

An example of rules which are registered in the abbreviation expansion rule storage 4 by the abbreviation expander 6 this way is shown in FIG. 2(b). In this example, a road name “CT 365” including an abbreviation stored in the abbreviation unexpanded word storage 5 and “Court 365” in which the abbreviation “CT” in “CT365” is expanded by the abbreviation expander 6 are registered, and “MARTINEDOCTOR HOSPITAL” corresponding to a facility name “MARTINE DR HOSPITAL” including an abbreviation is registered.

More specifically, the basic rules registered in advance, as shown in FIG. 2(a) , are stored in the abbreviation expansion rule storage 4, while rules, as shown in FIG. 2(b) , each of which is used to expand an abbreviation (abbreviation stored in the abbreviation unexpanded word storage 5) which is not stored at the beginning and cannot be expanded is additionally registered (stored) in the abbreviation expansion rule storage 4 by the abbreviation expander 6.

The voice synthesizer 7 generates a synthesized voice from the inputted character strings. In this embodiment, as pre-processing for performing the voice synthesis process, the voice synthesizer 7 determines whether or not an abbreviation is included in the facility name or the like which is the target for generation of a synthesized voice, when an abbreviation is included, expands this abbreviation with reference to the abbreviation expansion rule storage 4, and, when having failed in the expansion, registers the facility name or the like in the abbreviation unexpanded word storage 5. Because a known technique can be used as a voice synthesis method, the explanation of the voice synthesis method will be omitted hereafter.

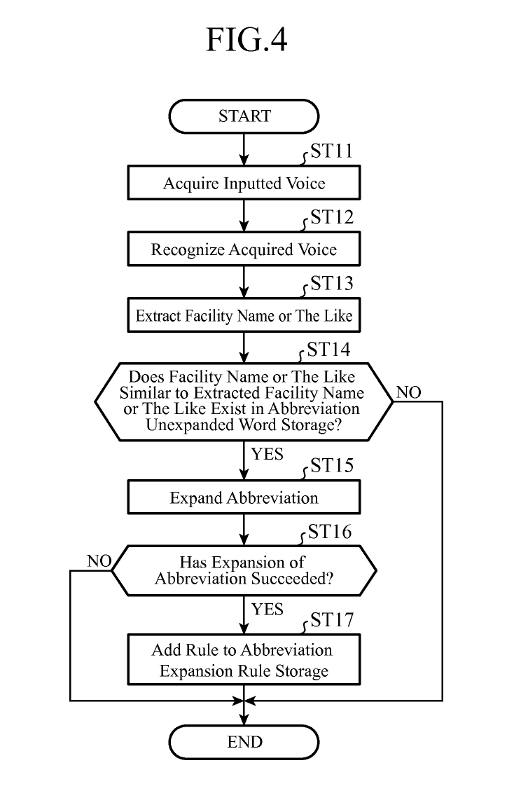

Next, the operation of the voice synthesis device in accordance with Embodiment 1 will be explained by using flow charts shown in FIGS. 3 and 4.

FIG. 3 is a flow chart showing a process of expanding an abbreviation, which is performed when generating a synthesized voice from an inputted text, the process being performed as pre-processing for the generation. Hereafter, the process will be explained by taking, as an example, expansion of an abbreviation included in a facility name or the like.

First, when character strings are inputted to the voice synthesizer 7, the voice synthesizer 7 divides the inputted character strings into units on each of which synthesized voice is to be performed by performing a known morphological analysis process or the like, and, after that, determines whether or not an abbreviation is included in the above-mentioned divided character strings with reference to the abbreviation expansion rule storage 4 (step ST01). Hereafter, a subsequent operation will be explained by assuming as an example that the target on which the above-mentioned determination is performed is a facility name or the like. When an abbreviation is not included (when NO in step ST01), the voice synthesizer ends the process. In contrast, when an abbreviation is included (when YES instep ST01), the voice synthesizer 7 expands the abbreviation with reference to the abbreviation expansion rule storage 4 (step ST02).

When having succeeded in the expansion of the abbreviation (when YES in step ST03), the voice synthesizer replaces the abbreviation with the expanded word (step ST04), and then ends the process. When having failed in the expansion of the abbreviation (when NO in step ST03), the voice synthesis processing unit 7 registers the facility name or the like including the abbreviation in the abbreviation unexpanded word storage 5 (step ST05), and ends the process.

Next, the operation will be explained while a concrete example is shown. Although a state in which information is registered is shown in FIG. 2(b), the operation will be explained hereafter on the assumption that nothing is registered.

When character strings “I will go to PARK AVE.” are inputted, because the abbreviation “AVE” defined in the abbreviation expansion rule storage 4 is included in “PARK AVE” which is a road name (when YES in step ST01), the voice synthesizer 7 acquires the expanded word “Avenue” corresponding to “AVE” with reference to the abbreviation expansion rule storage 4 (step ST02, and when YES in step ST03), and replaces “AVE” with “Avenue” (step ST04).

In contrast, when character strings “I will go to MARTINE DR HOSPITAL.” are inputted, because the abbreviation “DR” defined in the abbreviation expansion rule storage 4 is included in “MARTINE DR HOSPITAL” which is a facility name (when YES in step ST01), the voice synthesizer 7 tries to acquire the expanded word corresponding to “DR” with reference to the abbreviation expansion rule storage 4 (step ST02). However, in this case, because the position of the abbreviation “DR” in the facility name is “within words”, the rules shown in FIG. 2(a) cannot be applied. Further, because the character strings corresponding to “MARTINE DR HOSPITAL” are not registered in the rules of FIG. 2(b), the rules of FIG. 2(b) cannot be applied, and whether the expanded word is “Doctor” or “Drive” cannot be specified. In this case (when NO in step ST03), the voice synthesizer 7 registers “MARTINE DR HOSPITAL” in the abbreviation unexpanded word storage 5 (step ST05).

In addition, also when character strings “I will go to CT365.” are inputted, “CT365” is similarly registered in the abbreviation unexpanded word storage 5.

FIG. 4 is a flow chart showing a process of expanding an abbreviation included in a facility name or the like which is registered in the abbreviation unexpanded word storage 5 by the voice synthesizer 7 through the process shown in FIG. 3.

First, the voice acquiring unit 1 A/D converts a voice in a vehicle, which is collected by a microphone or the like, to acquire voice data in, for example, a PCM (Pulse Code Modulation) form (step ST11). In this case, it is assumed that a voice in a vehicle includes a voice uttered by a passenger, a voice outputted from a television or radio, e.g., a voice saying traffic information, and so on.

Next, the voice recognizer 2 recognizes the voice data acquired by the voice acquiring unit 1, and outputs a result of the recognition as character strings (step ST12). At this time, the voice recognizer 2 performs the recognition process even when not receiving the voice recognition start signal, as mentioned above.

The abbreviation expansion word extractor 3 then extracts a facility name or the like from the character strings outputted by the voice recognizer 2 with reference to the map data storage (not shown) (step ST13). Hereafter, an explanation will be made by assuming that abbreviation expansion words are a facility name or the like. The map data storage is the one in which map data, such as road data, intersection data, and facility data, are stored in a medium, such as a DVD-ROM, a hard disk, or an SD card. Instead of this map data storage, a map data acquiring unit that exists on a network and that can acquire map data information including road data via a communication network can be used.

The abbreviation expander 6 checks to see whether a facility name or the like similar to the facility name or the like extracted by the abbreviation expansion word extractor 3 exists in the abbreviation unexpanded word storage 5 (step ST14). In this case, the determination of whether or not they are similar to each other can be carried out by, for example, determining whether the number of matching words included in the character strings, these character strings consisting of one or more words which construct the facility name or the like, is equal to or larger than a predetermined threshold. When no similar facility name or the like exists in the abbreviation unexpanded word storage 5 (when NO in step ST14), the abbreviation expander ends the process.

In contrast, when a similar facility name or the like exists (when YES in step ST14), the abbreviation expander acquires the similar facility name or the like from the abbreviation unexpanded word storage 5, and compares this facility name or the like with the facility name or the like extracted in STEP13 to specify an expanded word corresponding to an abbreviation included in the extracted facility name or the like (step ST15). When an expanded word corresponding to an abbreviation is specified, i.e., when having succeeded in the expansion of an abbreviation (when YES in step ST16), the abbreviation expander registers the abbreviation and the expanded word corresponding to the abbreviation in the abbreviation expansion rule storage 4 while bringing the abbreviation and the expanded word corresponding to the abbreviation into correspondence with this abbreviation (step ST17). In contrast, when having failed in the expansion of an abbreviation (when NO in step ST16), the abbreviation expander ends the process.

Next, the operation will be explained while a concrete example is shown.

For example, assuming that the following conversation: “Did you go to the hospital yesterday?” “Yes. I went to MARTINE DOCTOR HOSPITAL.” takes place in the vehicle, the voice acquiring unit 1 acquires the voices (step ST11), and the voice recognizer 2 recognizes the voice data acquired by the voice acquiring unit 1 and outputs a result of the recognition as character strings (step ST12).

Next, the abbreviation expansion word extractor 3 extracts “MARTINE DOCTOR HOSPITAL” which is a facility name or the like from the recognition result (step ST13). The abbreviation expander 6 then checks to see whether a facility name or the like similar to “MARTINE DOCTOR HOSPITAL” exists in the abbreviation unexpanded word storage 5. It is assumed that the threshold is “the number of matching words included in the character strings consisting of one or more words is equal to or larger than is two or more.” In this case, because it is clear from a comparison between “MARTINE DR HOSPITAL” registered in the abbreviation unexpanded word storage 5 and “MARTINE DOCTOR HOSPITAL” that there is a match between the following two words: “MARTINE” and “HOSPITAL” in the former facility name or the like and those in the latter facility name or the like, it is determined that they are similar to each other (when YES in step ST14).

After that, the abbreviation expander 6 expands the abbreviation “DR.” In this case, because it is clear from the above comparison that the different character strings are “DR” and “DOCTOR”, “DOCTOR” is a candidate for the expanded word of “DR.” Referring to FIG. 2(a) of the abbreviation expansion rule storage 4, because “DOCTOR” is registered as an expanded word of “DR”, the expanded word of “DR” can be decided as “DOCTOR” (step ST15, and when YES in step ST16). Next, the abbreviation expander 6 registers the facility name or the like “MARTINE DOCTOR HOSPITAL” specified by the abbreviation expander 6 and the facility name or the like “MARTINE DR HOSPITAL” including the abbreviation in the abbreviation expansion rule storage 4 while bringing the facility name or the like “MARTINE DOCTOR HOSPITAL” into correspondence with the facility name or the like “MARTINE DR HOSPITAL”, as shown in FIG. 2(b) (step ST17).

Because the rules as shown in FIG. 2(b) are registered in the abbreviation expansion rule storage 4, as mentioned above, in the case of expanding the abbreviation “DR” in “MARTINE DR HOSPITAL” after the registration, the voice synthesizer 7 can expand the abbreviation “DR” in “MARTINE DR HOSPITAL” to “DOCTOR” by also referring to the rules, as shown in FIG. 2(b), which are additionally registered when referring to the abbreviation expansion rule storage 4 in step ST02 and then expanding the abbreviation.

As mentioned above, because the voice synthesis device in accordance with this Embodiment 1 regularly recognizes the contents of a passenger's utterance, and specifies a word before abbreviation corresponding to an abbreviation included in a facility name or the like which is included in the utterance contents by using the facility name or the like, the voice synthesis device can read the abbreviation out loud while preventing the passenger from being forced to perform a burdensome operation of, for example, registering the word before abbreviation corresponding to the abbreviation and using a reading method familiar to and appropriate for the passenger.

Further, when the voice synthesis device has been started even if no passenger is aware of the start, neither a passenger's manual operation for acquisition of a voice and start of voice recognition nor a passenger's intention to make an input is required because the voice synthesis device regularly performs acquisition of a voice and voice recognition.

The voice recognizer 2 and the abbreviation expansion word extractor 3 can be structured so as to be disposed in a server on a network and transmit and receive information via a communication unit (not shown).

In this case, first, the voice data acquired by the voice acquiring unit 1 is transmitted to the voice recognizer 2 of the server via the communication unit. The voice recognizer 2 recognizes the voice data transmitted thereto, and the abbreviation expansion word extractor 3 extracts a facility name or the like from a result of the recognition. After that, the voice recognizer transmits the extracted facility name or the like to the transmission source of the voice data. The voice synthesis device receives this facility name or the like, and performs a subsequent process of expanding an abbreviation by using the received facility name or the like.

In the case of the above-mentioned structure, the high processing capability and an abundant amount of memory of the server can be used. Therefore, fast and high-accuracy recognition, fast and exact extraction of a facility name or the like, a reduction in the processing load on the voice synthesis device, and so on can be accomplished.

Further, a plurality of specified or unspecified synthesized voice devices can be structured so as to transmit and receive information via the voice recognizer 2 and the abbreviation expansion word extractor 3, and a communication unit, and, when voice data transmitted by one of the devices is recognized and a facility name or the like is extracted from a result of the recognition, the extracted facility name or the like can be transmitted to one or more of the other voice synthesis devices. More specifically, processed results acquired by the voice recognizer 2 and the abbreviation expansion word extractor 3 can be shared among the plurality of devices.

In the case of the above-mentioned structure, because facility names or the likes extracted from many recognition results can be used, abbreviation unexpanded words can be expanded within a short period of time.

### Embodiment 2

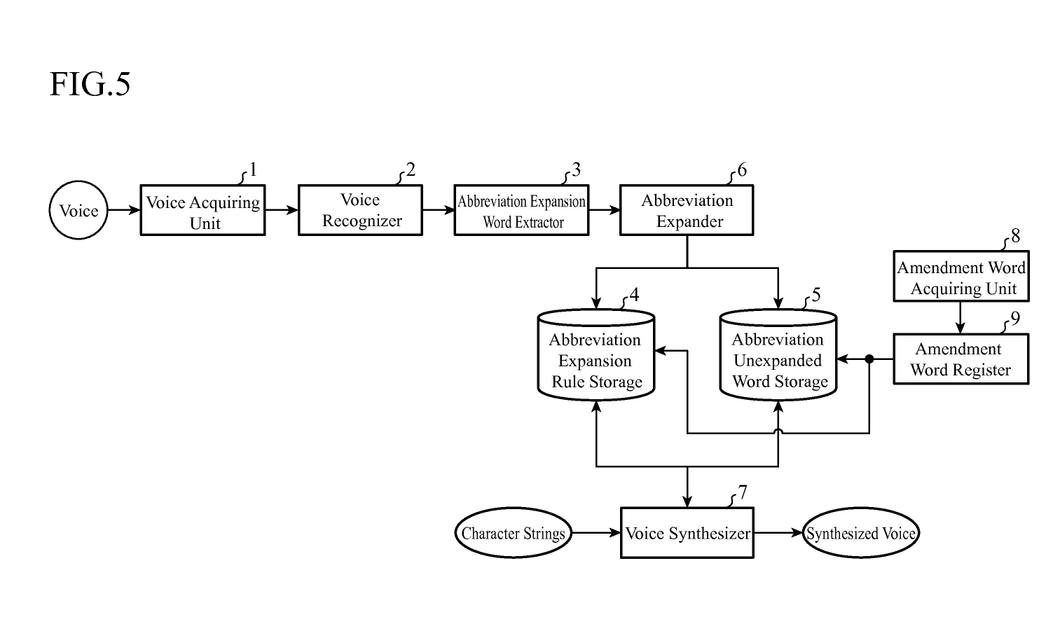

FIG. 5 is a block diagram showing an example of a voice synthesis device in accordance with Embodiment 2 of the present invention. The same structural components as those explained in Embodiment 1 are designated by the same reference numerals, and the duplicated explanation of the components will be omitted hereafter. The voice synthesis device in accordance with Embodiment 2 shown below further includes an amendment word acquiring unit 8 and an amendment word register 9 as compared with Embodiment 1. Further, although not illustrated, this voice synthesis device also includes an input unit that acquires an input signal generated by keys, a touch panel, or the like.

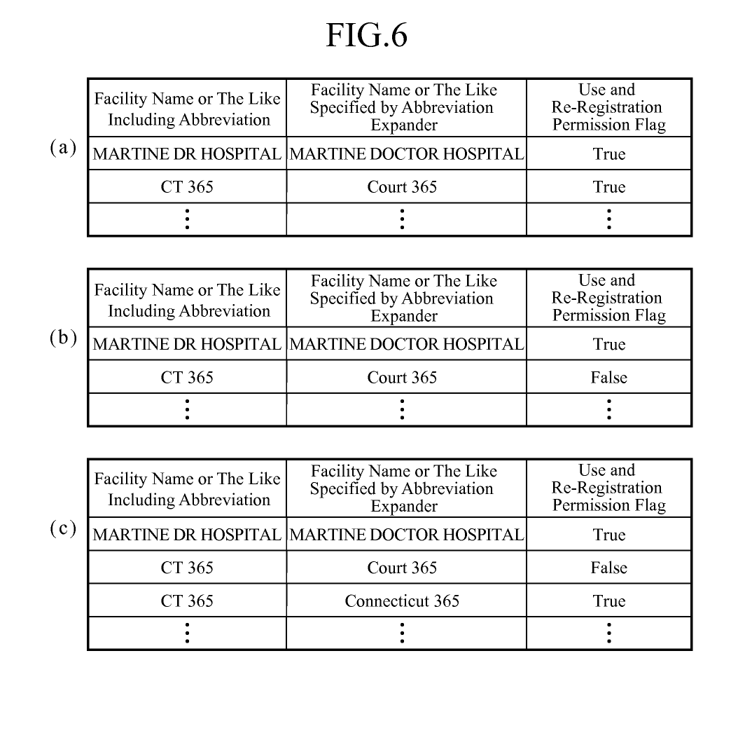

Further, FIG. 6 is a view showing an example of rules stored in an abbreviation expansion rule storage 4 in accordance with Embodiment 2. As shown in this FIG. 6, the abbreviation expansion rule storage 4 in accordance with this Embodiment 2 also has, as data, information about a use and re-registration permission flag (indicating permission when True, or prohibition when False) indicating whether or not a stored rule for expansion of an abbreviation is prohibited from being used and re-registered.

When words displayed on a display (not shown), such as an LCD (Liquid Crystal Display) or a touch panel consisting of a touch sensor, are selected (indicated) by a passenger, the amendment word acquiring unit 8 refers to map data and the abbreviation expansion rule storage 4, determines whether or not the selected (indicated) words are a facility name or the like including an abbreviation, and, when the words are a facility name or the like, acquires the words. The selection (indication) by a passenger is performed via an input unit (not shown), such as a touch panel, and this input unit constructs an amendment commander that accepts an amendment command. Further, because a known technique can be used as a method of specifying words which a passenger is going to select (indicate) from a signal which is outputted from the touch sensor because of the passenger's contact with the touch panel or the like, the explanation of the method will be omitted hereafter.

The amendment word register 9 registers the facility name or the like acquired by the amendment word acquiring unit 8 in an abbreviation unexpanded word storage 5, and prohibits a rule which is additionally registered in the abbreviation expansion rule storage 4 (e.g., a rule as shown in FIG. 2(b) explained in Embodiment 1) and which is used for expansion of the acquired facility name or the like from being used and re-registered. As a method of prohibiting a rule from being used and re-registered, for example, as shown in FIG. 6(a), a use and re-registration permission flag (indicating permission when True, or prohibition when False) should be newly added to each rule shown in FIG. 2(b), and, when this flag is set to indicate the prohibition of use and re-registration at the time when a voice synthesizer 7 expands an abbreviation, the corresponding rule should be prevented from being used. Further, when an abbreviation expander 6 registers an expansion rule, if the rule is a one for which the flag is set to indicate the prohibition of use and re-registration, the rule should be prevented from being registered.

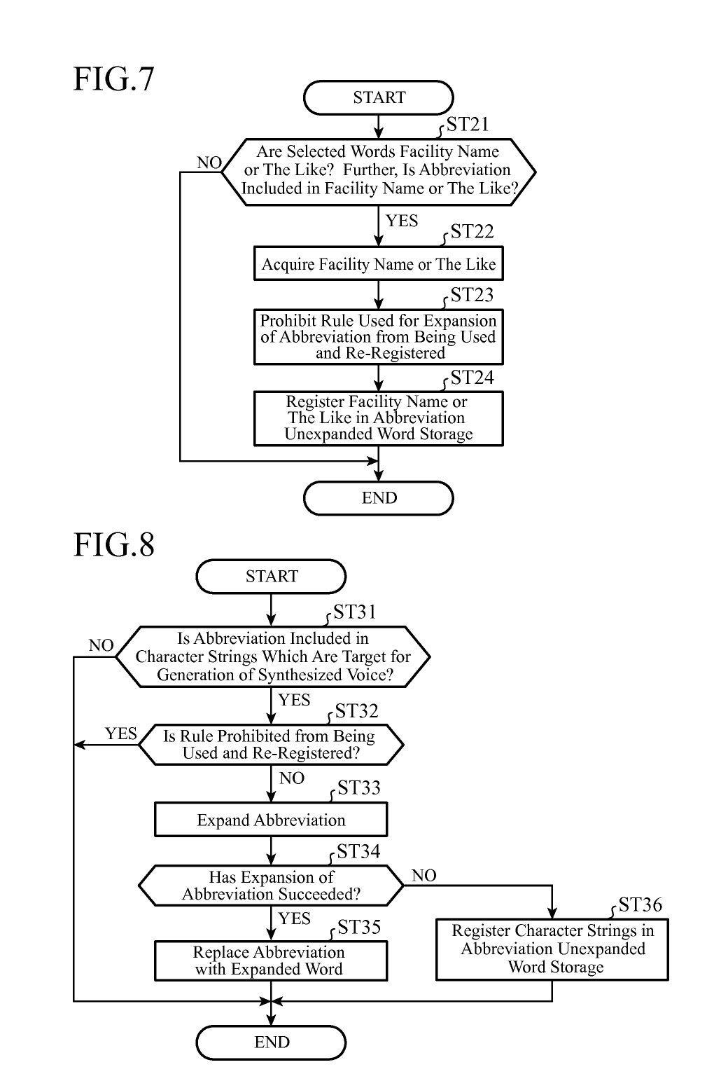

Next, the operation of the voice synthesis device in accordance with Embodiment 2 will be explained by using flow charts shown in FIGS. 7 to 9.

FIG. 7 is a flow chart showing a process of, when a facility name or the like displayed on a touch panel is selected (indicated) by a passenger, registering this facility name or the like in the abbreviation unexpanded word storage 5. Also hereafter, expansion of an abbreviation included in a facility name or the like will be explained as an example.

First, when words displayed on a touch panel are selected (indicated) by a passenger, this selection (indication) is accepted by the amendment commander and the amendment word acquiring unit 8 refers to map data and the abbreviation expansion rule storage 4 to determine whether or not the selected (indicated) words are a facility name or the like including an abbreviation, and, when the words do not meet the criterion, ends the process (when NO instep 21). In contrast, when the words meet the criterion, that is, when the selected (indicated) words are a facility name or the like and an abbreviation is included in the facility name or the like (when YES in step ST21), the amendment word acquiring unit acquires the facility name or the like (step ST22).

Next, the amendment word register 9 prohibits the rule which is used for expansion of the abbreviation included in the facility name or the like acquired by the amendment word acquiring unit 8 and which is stored in the abbreviation expansion rule storage 4 from being used and re-registered (step ST23). After that, the amendment word acquiring unit registers the facility name or the like in the abbreviation unexpanded word storage 5 (step ST24), and ends the process. FIG. 8 is a flow chart showing a process of generating a synthesized voice when a rule which is prohibited from being used and re-registered exists in the abbreviation expansion rule storage 4.

First, when character strings are inputted to the voice synthesizer 7, the voice synthesizer 7 divides the inputted character strings into units on each of which synthesized voice is to be performed by performing a known morphological analysis process or the like, and, after that, determines whether or not an abbreviation is included in the above-mentioned divided character strings with reference to the abbreviation expansion rule storage 4 (step ST31). Hereafter, a subsequent operation will be explained by assuming as an example that the target on which the above-mentioned determination is performed is a facility name or the like. When an abbreviation is not included (when NO in step ST31), the voice synthesizer ends the process.

In contrast, when an abbreviation is included (when YES in step ST31), the abbreviation expander 6 refers to the abbreviation expansion rule storage 4 to determine whether the rule, which the abbreviation expander is going to apply when expanding the abbreviation, is prohibited from being used and re-registered (step ST32) . When the rule is prohibited from being used and re-registered (when NO in step ST32), the abbreviation expander ends the process. In contrast, when the rule is not prohibited from being used and re-registered (when YES in step ST32), the abbreviation expander performs processes in step ST33 and subsequent steps. Because the processes of steps ST33 to ST36 are the same as those of steps ST02 to ST05 shown in FIG. 3 explained in Embodiment 1, the explanation of the processes will be omitted hereafter.

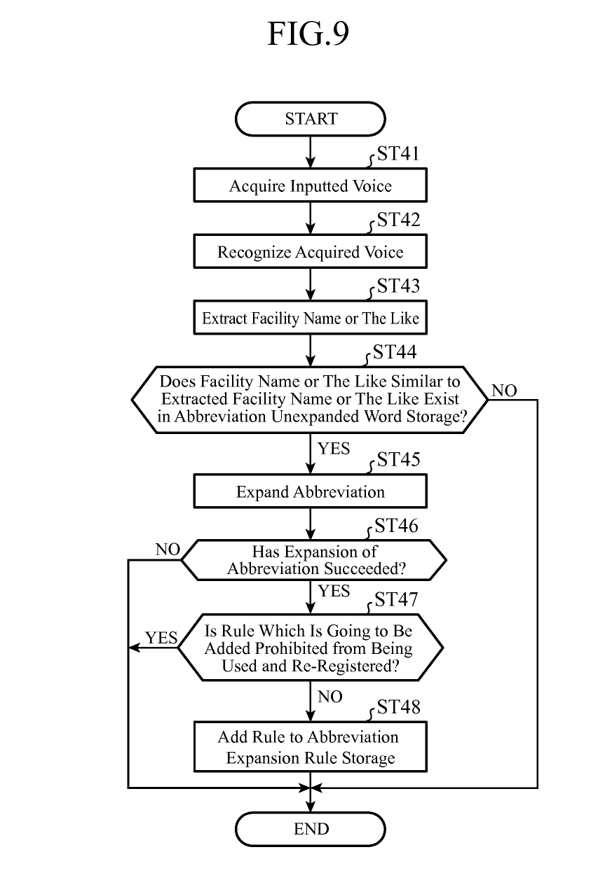

FIG. 9 is a flow chart showing a process of expanding an abbreviation when a rule which is prohibited from being used and re-registered exists in the abbreviation expansion rule storage 4.

Because processes of steps ST41 to ST46 shown in FIG. 9 are the same as those of steps ST11 to ST16 shown in FIG. 4 explained in Embodiment 1, the explanation of the processes will be omitted hereafter.

Then, when, in step ST46, having succeeded in expansion of an abbreviation (when YES in step ST46), and, when the abbreviation and the expanded word corresponding to the abbreviation are registered in the abbreviation expansion rule storage 4 as a rule, and this rule is a one which is prohibited from being used and re-registered (when YES in step ST47), the voice synthesis device ends the process. In contrast, when the rule is not a one which is prohibited from being used and re-registered (when NO in step ST47), the voice synthesis device registers the abbreviation and the expanded word corresponding to the abbreviation in the abbreviation expansion rule storage while bringing the abbreviation and the expanded word corresponding to the abbreviation into correspondence with the above-mentioned abbreviation (step ST48).

Next, the operation will be explained while a concrete example is shown.

For example, a case in which character strings “I will go to CT 365.” are inputted, and the voice synthesizer 7 refers to the rules registered in the abbreviation expansion rule storage 4 and shown in FIG. 6 (a) to expand “CT 365” to “Court 365” and generate a synthesized voice will be explained.

In this case, it is assumed that a passenger reads “CT 365” out loud as “Connecticut 365”, and “CT 365” on a touch panel which is read out loud erroneously is selected (indicated) by the passenger. As a result, the amendment word acquiring unit 8 refers to a rule (one in the second row of FIG. 5 (a)) of the abbreviation expansion rule storage 4, and determines that “CT 365” is a facility name or the like and includes an abbreviation (when YES in step ST21) and acquires this “Court 365” (step ST22).

The amendment word register 9 then sets the use and re-registration permission flag for the rule (the one in the second row of FIG. 5 (a)) of the abbreviation expansion rule storage 4, which is used for expansion of the abbreviation “CT 365”, to “False” (prohibition of use and re-registration) (step ST23) . FIG. 5 (b) shows a state in which the flag is changed this way.

At the same time as above, the amendment word register 9 registers “CT365” in the abbreviation unexpanded word storage 5 (step ST24).

After that, when “I will go to Connecticut 365.” is uttered, a rule (one in the third row of FIG. 5 (c)) in which the facility name or the like “Connecticut 365” is brought into correspondence with the abbreviation “CT 365” is additionally registered in the abbreviation expansion rule storage 4 according to flow charts shown in FIGS. 8 and 9. As a result, “I will go to CT 365.” is read out loud the next time and subsequent times as “I will go to Connecticut 365.” which the passenger desires.

Because the voice synthesis device is structured this way, the voice synthesis device can prevent an abbreviation from being continuously expanded according to an erroneous rule.

A rule for which the use and re-registration permission flag is set to “False” can be deleted when a new rule for the same abbreviation is added.

By doing this way, the voice synthesis device can prevent the memory usage from increasing due to rules which are not used.

The example in which the voice synthesis device in accordance with the present invention is applied to a car navigation system mounted in a moving object, and a voice inputted to the voice acquiring unit 1 is a passenger's utterance in the moving object, a voice from a radio or television, or the like is explained above. Because the voice synthesis device regularly recognizes not only a passenger's utterance but also a voice from a radio or television this way, and specifies a word before abbreviation corresponding to an abbreviation included in a facility name or the like included in the utterance contents by using the facility name or the like, the voice synthesis device can read the abbreviation out loud while preventing the passenger from being forced to perform a burdensome operation of, for example, registering the word before abbreviation corresponding to the abbreviation and using a reading method familiar to and appropriate for the passenger.

While the invention has been described in its preferred embodiments, it is to be understood that an arbitrary combination of two or more of the above-mentioned embodiments can be made, various changes can be made in an arbitrary component in accordance with any one of the above-mentioned embodiments, and an arbitrary component in accordance with any one of the above-mentioned embodiments can be omitted within the scope of the invention.

### INDUSTRIAL APPLICABILITY

The voice synthesis device in accordance with the present invention can be applied to a car navigation system and so on.

### EXPLANATIONS OF REFERENCE NUMERALS

1 voice acquiring unit, 2 voice recognizer, 3 abbreviation expansion word extractor, 4 abbreviation expansion rule storage, 5 abbreviation unexpanded word storage, 6 abbreviation expander, 7 voice synthesizer, 8 amendment word acquiring unit, 9 amendment word register.

1. A voice synthesis device that generates a synthesized voice from inputted character strings, said voice synthesis device comprising:
a voice acquiring unit that detects and acquires an inputted voice;
a voice recognizer that regularly recognizes voice data acquired by said voice acquiring unit when said voice synthesis device is started;
an abbreviation expansion word extractor that extracts abbreviation expansion words from character strings which are a recognition result outputted by said voice recognizer;
an abbreviation expansion rule storage that stores rules for expansion of abbreviations;
a voice synthesizer that generates a synthesized voice from said inputted character strings, and, when generating said synthesized voice, expands an abbreviation included in said inputted character strings by referring to said abbreviation expansion rule storage;
an abbreviation unexpanded word storage that registers words for which said voice synthesizer has failed in expansion of an abbreviation; and
an abbreviation expander that uses the abbreviation expansion words extracted by said abbreviation expansion word extractor to expand an abbreviation included in abbreviation unexpanded words registered in said abbreviation unexpanded word storage by referring to said abbreviation expansion rule storage.

2. The voice synthesis device according to claim 1, wherein said voice synthesis device further comprises an amendment commander that accepts an amendment command, an amendment word acquiring unit that acquires amendment words on a basis of the command accepted by said amendment commander, and an amendment word register that registers the amendment words acquired by said amendment word acquiring unit in said abbreviation unexpanded word storage.

3. The voice synthesis device according to claim 1, wherein said voice synthesis device is mounted in a moving object, the voice inputted to said voice acquiring unit is a passenger's utterance in said moving object, a voice from a radio, or a voice from a television.
